(19) United States
(12) Patent Application Publication
(10) Pub. No.: US 2023/0076939 A1
(43) Pub. Date: Mar. 9, 2023

(54) Encoding and Decoding Visual Content Including Polygonal Meshes

(71) Applicant: Apple Inc., Cupertino, CA (US)

(72) Inventors: Khaled Mammou, Cupertino, CA (US); Alexandros Tourapis, Los Gatos, CA (US); Arnold H. Cachelin, Sunnyvale, CA (US); David Flynn, Darmstadt (DE); Fabrice A. Robinet, Sunnyvale, CA (US); Jungsun Kim, Sunnyvale, CA (US)

(21) Appl. No.: 17/942,032

(22) Filed: Sep. 9, 2022

Related U.S. Application Data
(60) Provisional application No. 63/242,465, filed on Sep. 9, 2021.

(51) Int. Cl. G06T 17/10; G06T 17/20; G06T 9/00

(52) U.S. Cl. CPC G06T 17/10; G06T 17/20; G06T 9/001

(57) ABSTRACT

In an example method, a system obtains first data representing a plurality of polygons of a polygon mesh, and performs several operations for each of the polygons, including (i) determining a number of sample points for that polygon, where the number of sample points is determined based on at least one of an area of that polygon or an area of the polygon mesh, (ii) determining a distribution of the sample points for that polygon, and (iii) sampling the polygon mesh in accordance with the determined number of sample points and the determined distribution of sample points, where sampling the polygon mesh includes determining one or more characteristics of the polygon mesh at each of the sample points. The system also outputs second data representing the one or more characteristics of the polygon mesh at one or more of the sample points.

### CROSS-REFERENCE TO RELATED APPLICATION

This application claims priority to U.S. Provisional Patent Application No. 63/242,465, filed Sep. 9, 2021, the entire contents of which are incorporated herein by reference.

### TECHNICAL FIELD

This disclosure relates generally to encoding and decoding visual content including polygonal meshes.

### BACKGROUND

Computer systems can be used to generate and display visual content. As an example, a computer system can generate a three-dimensional model representing the physical characteristics and/or visible appearance of an object. Further, the computer system can render a visual representation of the three-dimensional model, such that it can be viewed by a user on a display device. In some implementations, a visual representation of the three-dimensional model can be displayed according to two dimensions and/or three dimensions

### SUMMARY

In an aspect, a method includes obtaining, by one or more processors, first data representing a plurality of polygons of a polygon mesh; for each of the polygons: (i) determining, by the one or more processors, a number of sample points for that polygon, where the number of sample points is determined based on at least one of an area of that polygon or an area of the polygon mesh, (ii) determining, by the one or more processors, a distribution of the sample points for that polygon, and (iii) sampling, by the one or more processors, the polygon mesh in accordance with the determined number of sample points and the determined distribution of sample points, where sampling the polygon mesh comprises determining one or more characteristics of the polygon mesh at each of the sample points; and outputting, by the one or more processors, second data representing the one or more characteristics of the polygon mesh at one or more of the sample points.

Implementations of this aspect can include one or more of the following features.

In some implementations, the plurality of polygons can include a plurality of triangles.

In some implementations, the polygon mesh can defines one or more three-dimensional surfaces.

In some implementations, the one or more characteristics of the polygon mesh at each of the sample points can include at least one of: a spatial location corresponding to that sample point, a color corresponding to that sample point, a texture corresponding to that sample point, or a surface normal corresponding to that sample point.

In some implementations, for each of the polygons, the number of sample points for that polygon can be determined based on the area of that polygon, the area of the polygon mesh, and a specified number of sample points for the polygon mesh.

In some implementations, for each of the polygons, the number of sample points for that polygon can be determined based on the area of the polygon mesh, a pre-determined number of sample points for the polygon mesh, and a plurality of vectors representing a plurality of edges of the polygon.

In some implementations, for each of the polygons, determining the distribution of the sample points for that polygon can include obtaining a template representing a spatial pattern of sample points, and applying at least a portion of the template to the polygon.

In some implementations, for each of the polygons, determining the distribution of the sample points for that polygon further can include at least one of: rotating the template relative to the polygon, or translating the template relative to the polygon.

In some implementations, for each of the polygons, determining the distribution of the sample points for that polygon can also include applying multiple instances of the template to the polygon.

In some implementations, for each of the polygons, determining the distribution of the sample points for that polygon can include determining a random or pseudo-random spatial pattern of sample points.

In some implementations, for each of the polygons, determining the distribution of the sample points for that polygon can include adding a sample point to the distribution, determining whether the added sample point is less than a threshold distance from one or more other sample points in the distribution, and responsive to determining that the added sample point is less than the threshold distance from the one or more other sample points in the distribution, removing the added sample point from the distribution.

In some implementations, the one or more sample points can be determined based on a Morton order of the one or more sample points.

In some implementations, the one or more sample points can be determined by: quantizing a spatial region of the polygon mesh into a plurality of cubes, determining a first cube corresponding to the added sample point, determining one or more second cubes adjacent to the first cube, and selecting the one or more sample points from the one or more second cubes.

In some implementations, the method can also include segmenting at least one of the polygons into two corresponding polygons.

In some implementations, for each of the polygons, determining the distribution of the sample points for that polygon can include selecting one or more vertices of the polygon as one or more of the sample points.

Other implementations are directed to systems, devices, and non-transitory, computer-readable media having instructions stored thereon, that when executed by one or more processors, causes the one or more processors to perform operations described herein.

The details of one or more embodiments are set forth in the accompanying drawings and the description below. Other features and advantages will be apparent from the description and drawings, and from the claims.

### BRIEF DESCRIPTION OF DRAWINGS

FIG. 1 is a diagram of an example system for encoding and decoding visual content.

FIG. 2A is a diagram of an example polygon mesh.

FIG. 2B is a diagram of an example spatial pattern of sample points for sampling a polygon mesh.

FIG. 3 is a diagram of an example encoder.

FIG. 4 is a diagram of further example spatial patterns of sample points for sampling a polygon mesh.

FIG. 5 is a diagram of an example alignment between a template of sample point and polygon.

FIG. 6 is a diagram of example polygon segmentations.

FIG. 7 is a diagram of an example Morton order.

FIG. 8 is a diagram of example N-connectivity configurations.

FIG. 9 is a diagram of an example bounding cube partitioned into smaller sub-cubes.

FIG. 10 is a diagram of an example process for encoding information regarding a polygon mesh.

FIG. 11 is a diagram of an example device architecture for implementing the features and processes described in reference to FIGS. 1-10.

### DETAILED DESCRIPTION

In general, computer systems can generate visual content and present the visual content to one or more users. As an example, a computer system can generate a three-dimensional model that represents the physical characteristics and/or visual appearance of an object. The three-dimensional model can include, for instance, one or more meshes (e.g., polygon meshes) that define or otherwise approximate the shape of that object. A polygon mesh can include a collection of interconnected vertices that form several edges (e.g., lines) and faces (e.g., polygons). Together, the vertices, edges, and faces can define a surface representing the shape of an object.

Further, the computer system can render a visual representation of the three-dimensional model, such that it can be viewed by a user on a display device. For example, the computer system can render a visual representation of a polygon mesh in two dimensions, such that the content is suitable for display on a two-dimensional display (e.g., a flat panel display, such as a liquid crystal display or a light emitting diode display). As another example, the computer system can render a visual representation of a polygon mesh in three dimensions, such that the content is suitable for display on a three-dimensional display (e.g., a holographic display or a headset).

In some implementations, a computer system can encode information regarding a polygon mesh in one or more data structures or signals, such that the polygon mesh (or an approximation thereof) can be recreated or regenerated in the future. For example, a first computer system can generate a data stream (e.g., a bit stream) that indicates the position of each of the polygon mesh's vertices, the interconnections between the vertices, the characteristics of the polygon mesh at one or more points, and other information of the polygon mesh, and provide the data stream to a second computer system. The second computer system can decode the data stream to extract the encoded information, and generate a representation of the polygon mesh based on the extracted information.

In some implementation, information regarding the polygon mesh can be encoded by determining the characteristics of the polygon mesh at several points on the polygon mesh (e.g., sampling the polygon mesh at several sample points), and storing data representing at least some of the determined characteristics in a data structure, such as a bit stream. Further, the sample points can be selected such that the data structure efficiently stores information that can be used to render a high quality visual representation of a polygon mesh.

The techniques described herein can provide various technical benefits. In some implementations, the techniques described herein can be used to encode information regarding polygon meshes with a higher degree of efficiency than might otherwise be possible absent performance of these techniques. As an example, information regarding polygon meshes can be encoded in a data stream that has a smaller size (or length) compared to data streams generated using other techniques. This enables computer systems to reduce the amount of resources that are expended to transmit, store, and/or process the data stream. For instance, these techniques can reduce an expenditure of computational resources (e.g., CPU utilization), network resources (e.g., bandwidth utilization), memory resources, and/or storage resources by a computer system in generating, storing, transmitting, and processing visual content. Further, in some implementations, these techniques also enable computer systems to transmit, store, and/or process the data stream more quickly, such that the delay and/or latency with which visual content is displayed to a user is reduced. Further still, in some implementations, these techniques also enable computer systems to render a visual representation of a polygon mesh according to a high degree of quality (e.g., a high degree of detail, fidelity, etc.).

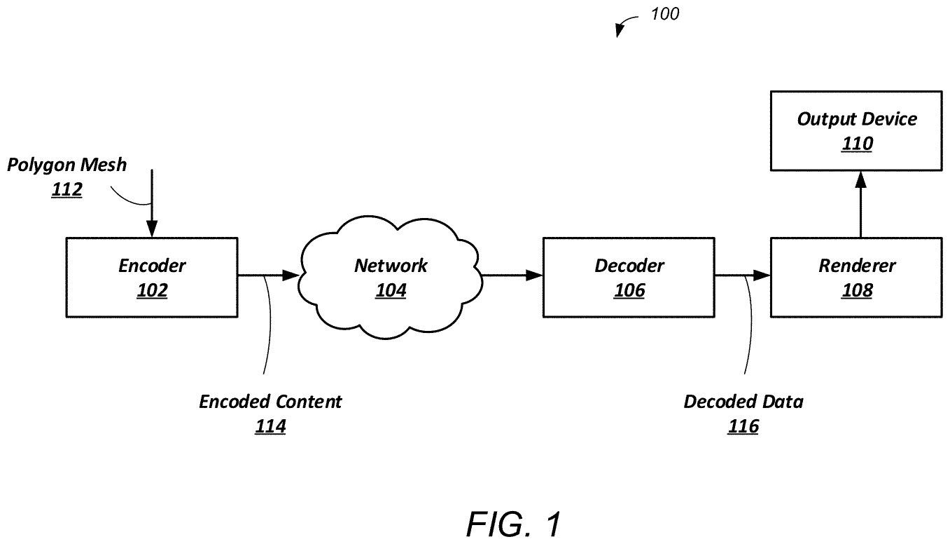

FIG. 1 is a diagram of an example system 100 for processing and displaying visual content. The system 100 includes an encoder 102, a network 104, a decoder 106, a renderer 108, and an output device 110.

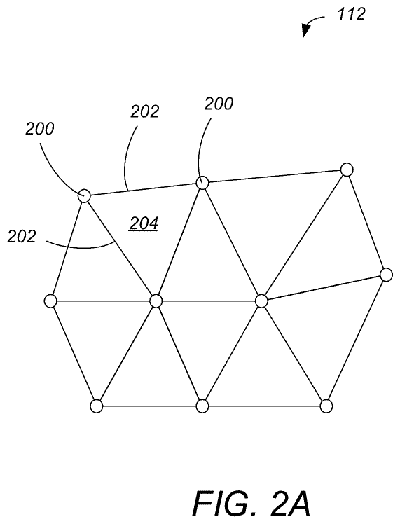

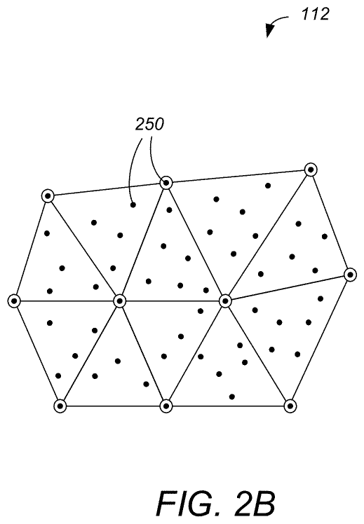

During an example operation of the system 100, the encoder 102 receives information regarding a polygon mesh 112. An example of a polygon mesh 112 is shown in FIG. 2A. The polygon mesh 112 includes a collection of vertices 200 that are interconnected by respective edges 202 (e.g., lines extending between two respective vertices). Further, the edges 202 define a collection of polygonal faces 204 (e.g., regions enclosed by the edges). Together, the vertices 200, edges 202, and faces 204 define one or more surfaces representing the shape of an object.

In some implementations, the polygon mesh 112 can include triangular faces (e.g., as shown in FIG. 2A). In some implementations, the polygon mesh 112 can include faces having other shapes (e.g., quadrilaterals, pentagons, hexagons, etc.). In some implementations, the polygon mesh 112 can include faces having a single shape only. In some implementations, the polygon mesh 112 can include faces having two or more different shapes (e.g., a combination of triangle faces, quadrilateral faces, and/or faces having any other shape).

In some implementations, the polygon mesh 112 can represent a three-dimensional shape of an object. In some implementations, the polygon mesh 112 can represent a two-dimensional shape of an object.

In some implementations, the polygon mesh 112 can be generated using a photogrammetry process. For example, the system 100 (or another system) can receive image data regarding one or more objects obtained from several different perspectives (e.g., a series of images taken of the one or more objects from different angles and/or distances). Based on the image data, the system 100 (or another system) can determine the shape of the object, and generate one or more polygon meshes having or approximating that shape.

In some implementations, the polygon mesh 112 can be generated based on measurements obtained by depth sensing systems, three-dimensional cameras, and/or three-dimensional scanners. For example, a LIDAR system can obtain information regarding an object, such as a point cloud representing the spatial locations of several points on the object's surface. Based on the point cloud, the system 100 (or another system) can determine the shape of the object, and generate one or more polygon meshes having or approximating that shape.

The encoder 102 generates encoded content 114 based on the polygon mesh 112. The encoded content 114 includes information representing the characteristics of the polygon mesh 112, and enables computer systems (e.g., the system 100 or another system) to recreate the polygon mesh 112 or approximation thereof. As an example, the encoded content 114 can include one or more data streams (e.g., bit streams) that indicate the position of one or more of the vertices 200 of the polygon mesh, one or more interconnections between the vertices 200 (e.g., the edges 202), and/or one or more faces 204 defined by the edges 202. Further, the encoded content 114 can include information regarding additional characteristics of the polygon mesh 112, such as one or more colors, textures, visual patterns, opacities, and/or other characteristics associated with the polygon mesh 112 (or a portion thereof).

In some implementations, encoder 102 can determine the characteristics of the polygon mesh 112 at one or more points on the polygon mesh 112, and encode information representing at least some of the determined characteristics in the encoded content 114. For instance, the encoder 102 can determine a spatial pattern of sample points on the polygon mesh 112, and sample the characteristics of the polygon mesh at each of those sample points. As an example, the characteristics of the polygon mesh 112 at a sample point can include a spatial location of that sample point (e.g., expressed according to a coordinate system, such as a Cartesian coordinate system, cylindrical coordinate system, spherical coordinate system, etc.). As further examples, the characteristics of the polygon mesh 112 at a sample point can include a color of the polygon mesh 112 at that sample point, or a surface normal of the polygon mesh 112 at the sample point. As another example, the characteristics of the polygon mesh 112 at a sample point can include information regarding a texture of the polygon mesh 112 at that sample point, such as a texture coordinate (e.g., a coordinate that defines how an image or portion of an image is mapped to the polygon mesh 112), or a texture map that is applied to the polygon mesh 112 to provide three-dimensional surface material descriptions, such as specular reflection, roughness, a bump map, a displacement amount, etc. The characteristics of the polygon mesh 112 can also include any other information regarding the polygon mesh 112, either instead of or in addition to the examples described above. Further, the encoder 102 can include information representing some or all of these characteristics in the encoded content 114.

An example spatial pattern of sample points 250 (represented by solid circles) is shown in FIG. 2B. As shown in FIG. 2B, at least some of the sample points 250 can be located on the polygonal faces 204 of the polygon mesh 112 (e.g., within the edges 202). Further, at least some of the sample points 250 can be located on the vertices 200 of the polygon mesh 112. Example techniques for determining a spatial pattern of sample points 250 are described in further detail below.

The encoded content 114 is provided to a decoder 106 for processing. In some implementations, the encoded content 114 can be transmitted to the decoder 106 via a network 104. The network 104 can be any communications networks through which data can be transferred and shared. For example, the network 104 can be a local area network (LAN) or a wide-area network (WAN), such as the Internet. The network 104 can be implemented using various networking interfaces, for instance wireless networking interfaces (e.g., Wi-Fi, Bluetooth, or infrared) or wired networking interfaces (e.g., Ethernet or serial connection). The network 104 also can include combinations of more than one network, and can be implemented using one or more networking interfaces.

The decoder 106 receives the encoded content 114, and extracts information regarding the polygon mesh 112 included in the encoded content 114 (e.g., in the form of decoded data 116). For example, the decoder 106 can extract information regarding the vertices 200, edges 202, and/or faces 204, such as the location of each of the vertices 200, the interconnections between the vertices 200 (e.g., the edges 202), and the faces 204 formed by those interconnections. As another example, the decoder 106 can extract information regarding additional characteristics of the polygon mesh 112, such as one or more colors, textures, visual patterns, opacities, and/or other characteristics associated with the polygon mesh 112 (or a portion thereof). As another example, the decoder 106 can extract information regarding the characteristics of the polygon mesh 112 at some or all of the sample points 250.

The decoder 106 provides the decoded data 116 to the renderer 108. The renderer 108 renders content based on the decoded data 116, and presents the rendered content to a user using the output device 110. As an example, if the output device 110 is configured to present content according to two dimensions (e.g., using a flat panel display, such as a liquid crystal display or a light emitting diode display), the renderer 108 can render the content according to two dimensions and according to a particular perspective, and instruct the output device 110 to display the content accordingly. As another example, if the output device 110 is configured to present content according to three dimensions (e.g., using a holographic display or a headset), the renderer 108 can render the content according to three dimensions and according to a particular perspective, and instruct the output device 110 to display the content accordingly.

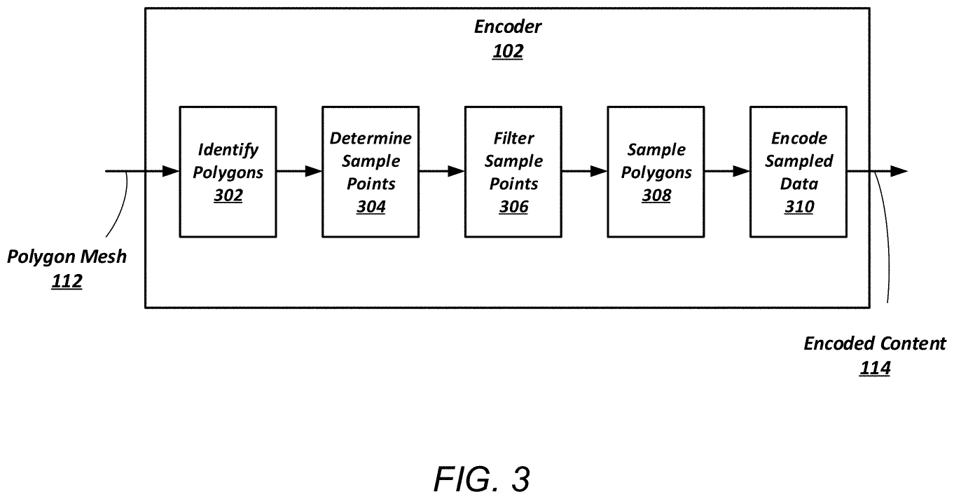

FIG. 3 shows a schematic representation of the encoder 102 in greater detail.

As shown in FIG. 3, the encoder 102 includes a module 302 that receives information regarding the polygon mesh, and identifies one or more of the polygons in that polygon mesh 112. As an example, if the polygon mesh 112 includes one or more triangles, the module 302 can identify each of the triangles, and assign identifying information (e.g., an index value) to each of the triangles.

Further, the encoder 102 includes a module 304 that determines one or more sample points for sampling each of the identified polygons. As an example, for each of the polygons, the module 304 can determine a spatial pattern of sampling points for that polygon.

Further, the encoder optionally includes a module 306 that filters at least some of the sample points, such that some of the sample points are discarded or otherwise omitted from further processing. As an example, the module 306 can remove at least some of the sample points to reduce the size or length of the encoded content. As another example, the module 306 can remove at least some of the sample points to enhance the quality and/or consistency of the encoded content.

Further, the encoder 102 includes a module 308 that samples each of the identified polygons at the determined sampled points (e.g., the sample points determined by the module 304, or the sample points that remain after being filtered by the sample points 306). As an example, for each of the polygons, the module 304 can determine the characteristics of that polygon mesh 112 at each of the sampling points.

Further, the encoded includes a module 310 that encodes information regarding the sampled sample points to generate the encoded content 114. As described above, in some implementations, the encoded content 114 can include one or more data streams (e.g., bit streams) that represent the characteristics of the polygon mesh 112 at some or all of the sample points.

In some implementations, the module 304 can determine a spatial pattern of sample points for each of the identified polygons on a per polygon basis. As an example, for each of the polygons, the module 304 can determine a number of sample points for that polygon (e.g., based on the characteristics of the polygon and/or the polygon mesh 112 as a whole). Further, the module 304 can distribute the determined number of sample points along the polygon according to a particular spatial pattern.

In some implementations, the number of sample points for each polygon can be determined based, at least in part, on the area of the polygon and/or the area of the entire polygon mesh 112. For instance, the number of sample points of each polygon can be proportional of the area of the polygon, relative to the area of the entire polygon mesh 112. As an example, the number of sample points in a polygon can be determined based on the following function:

TargetPolygonPointCount=TargetMeshPointCount*PolygonArea/MeshArea (Eq.1),

where “TargetPolygonPointCount” is the number of sample points for the polygon, “TargetMeshPointCount” is the total number of sample points that has been allotted for the entire polygon mesh, “PolygonArea” is the area (e.g., surface area) of the polygon, and “MeshArea” is the area (e.g., surface area) of the entire polygon mesh.

In some implementations, the total number of sample points that has been allotted for the entire polygon mesh (e.g., “TargetMeshPointCount”) can be automatically selected by the encoder 102 (e.g., based on the size of the polygon mesh, a specified level of quality or detail for the encoding process, etc.). In some implementations, “TargetMeshPointCount” can be selected, at least in part, based on input by a user.

In some implementations, the number of sample points for each polygon can be selected based on vectors representing edges of that polygon. As an example, the number of sample points in a polygon can be determined based on the following functions:

S=2*TargetMeshPointCount/MeshArea (Eq.2),

TargetPolygonPointCount=S*/(dot(N,N)) (Eq.3),

N=cross(B−A,C−A) (Eq. 4),

where “S” is a sampling rate for the encoded bit stream, “TargetMeshPointCount” is the total number of sample points that has been allotted for the entire polygon mesh, “MeshArea” is the area (e.g., surface area) of the entire polygon mesh, and “TargetPolygonPointCount” is the number of sample points for the polygon. Further, “N” is a three-dimensional vector that is determined based on vectors “A,” “B,” and “C,” where the vectors “A,” “B,” and “C” represent the edges of the polygon (e.g., intersecting vectors that form a triangle).

As described above, in some implementations, the total number of sample points that has been allotted for the entire polygon mesh (e.g., “TargetMeshPointCount”) can be automatically selected by the encoder 102 (e.g., based on the size of the polygon mesh, a specified level of quality or detail for the encoding process, etc.). In some implementations, “TargetMeshPointCount” can be selected, at least in part, based on input by a user.

Upon determining a number of sample points for a polygon, the module 304 can determine a spatial pattern of sample points for that polygon having the determined number of sample points.

In some implementations, the spatial pattern of sample points for a polygon can be selected such that a sample point coincides with some or all of the vertices of that polygon. As an example, if the polygon is a triangle, the spatial pattern of sample points can include up to three sample points coinciding with the vertices of the triangle. In some implementations, sample points coinciding with the vertices of the polygon can be selected first, prior to selecting one or more other sample points for the polygon (e.g., using other techniques, such as those described below).

In some implementations, the spatial pattern of sample points can be determined by distributing the determined number of sample points randomly or pseudo-randomly. As an example, the location of each of the sample points can be selected according to a R² distribution, a Halton sequence, a Kronecker random matrix, a Niederreiter sequence, a Sobol sequence, a random sequence, and/or any combination thereof.

In some implementations, the spatial pattern of sample points can be determined using one or more templates, each representing a respective spatial pattern of sample points. These templates can be pre-determined (e.g., generated prior to the receipt of the polygon mesh 112 by the encoder 102), and can be retrieved and used by the encoder 102 for encoding one or more polygon meshes.

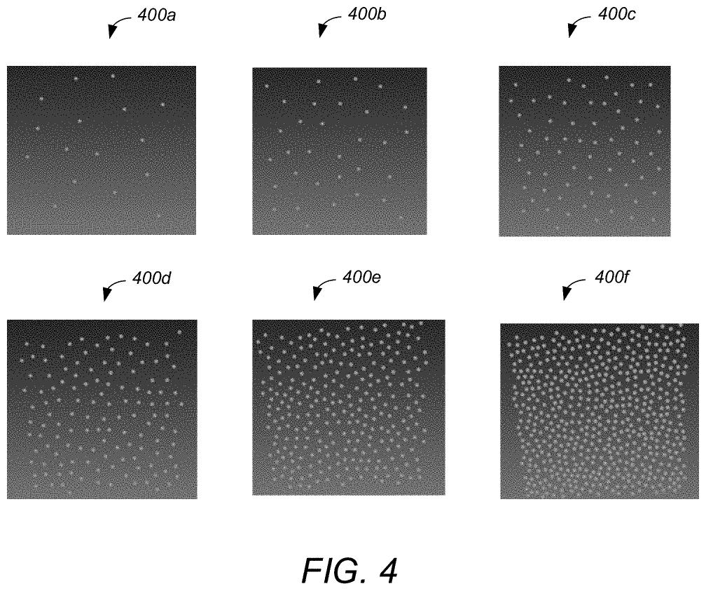

In some implementations, the sample points can be eventually distributed or substantially evenly distributed. For example, the sample points can be separated by one another by no more than a particular maximum distance and/or no less than a particular minimum distance. Further, in some implementations, templates can be generated such that the sample points in the templates have a hierarchical structure (sometimes also referred to as a pyramidal structure). A hierarchical structure refers to a distribution of points that maintains even spacing (e.g., no points are within a particular minimum distance from one another) over a plane as the number of points is reduced, such that the density of points increases linearly with the number of points while maintaining a smooth distribution. Accordingly, a hierarchical structure can be viewed as a pyramid of smooth distributions at different densities. Further, the hierarchical structure can be selected such that a minimum distance between points decreases with the number of points. As an example, the minimum distance between points can decrease with the square root of the number of points. FIG. 4 shows several example spatial patterns of sample points 400a-400f having a hierarchical pyramidal structure.

An even (or substantially even) distribution pattern of sample points can be beneficial, for example, in enabling the encoder 102 to sample the characteristics of the polygon mesh 112 in a consistent manner. Accordingly, the encoded content 114 can, at least in some implementations, include information that enable computer systems to render a visual representation of the polygon mesh 112 according to a greater degree of accuracy and/or detail (e.g., compared to the visual representation that would be rendered using encoded content 114 in which a polygon mesh 112 was sampled in an uneven or inconsistent manner).

In some implementations, a template can include a list of several sample points and their corresponding locations within the spatial pattern. In some implementations, the list can be provided in the form of a look up table or other appropriate data structure. In some implementations, the list can include a specified number of sample points (e.g., 1024 sample points, 2048 sample points, 4096 sample points, 8192 sample points, or any other number of sample points), and the module 304 can select some or all of the sample points from the list.

In some implementations, a template can specify the locations of sample points within the boundaries of a two-dimensional region (e.g., a quadrilateral, such as a unit square). Further, the encoder can align the two-dimensional region with a polygon, such that the polygon coincides with at least some of the sample points in the two-dimensional region. The sample points that coincide with the polygon (e.g., the sample points enclosed by the polygon's edges) can be selected as the sample points for that polygon, whereas the sample points that are located outside of the polygon (e.g., the sample points that are not enclosed by the polygon's edges) can be discarded or omitted.

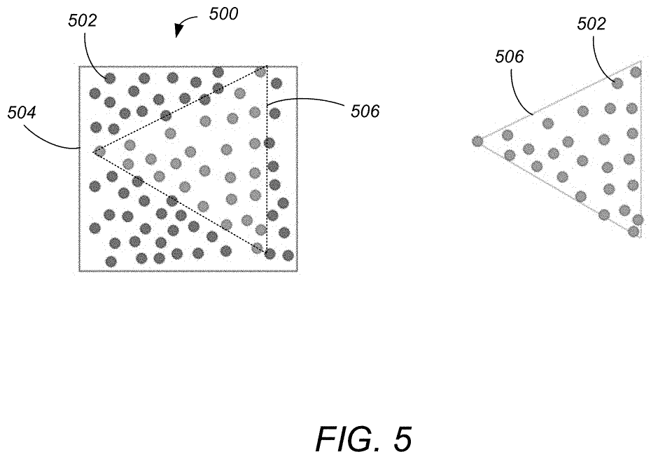

As an example, FIG. 5 shows a template 500 having a number of sample points 502 distributed along a square region 504. The module 304 can align a polygon 506 and the template 500, such that the polygon 506 is enclosed by the square region 504. The sample points 502 that coincide with the polygon 506 can be selected as the sample points for the polygon 506, whereas the sample points 502 that are located outside of the polygon 506 can be discarded or omitted.

In some implementations, the module 304 can align the polygon 506 and the template 500 by translating, rescaling (e.g., resizing), and/or rotating the template 500 (e.g., the two dimensional region and the sample points within it) relative to the polygon 506. In some implementations, the module 304 can align the polygon 506 and the template 500 by translating, rescaling, and/or rotating the polygon 506 relative to the template 500. In some implementations, the module 304 can align the polygon 506 and the template 500 by translating, rescaling, and/or both the polygon 506 and the template 500 relative to one another.

In some implementations, the module 304 can determine a spatial pattern of sample points for a polygon using a single template (e.g., by aligning a single template with the polygon, such that the template encloses some or all of the polygon). In some implementations, the module 304 can determine a spatial pattern of sample points for a polygon using several instances of a template (e.g., by tiling or repeating multiple instances of a template across the polygon, such that they collectively enclose some or all of the polygon). In some implementations, the module 304 can determine a spatial pattern of sample points for a polygon using several different templates (e.g., by aligning several different templates across the polygon, such that they collectively enclose some or all of the polygon).

In some implementations, if the determined number of sample points for a polygon is less than the number of sample points in a template, the module 304 can select a subset of the sample points in the template for sampling the polygon (e.g., randomly, pseudo-randomly, or according to a particular order).

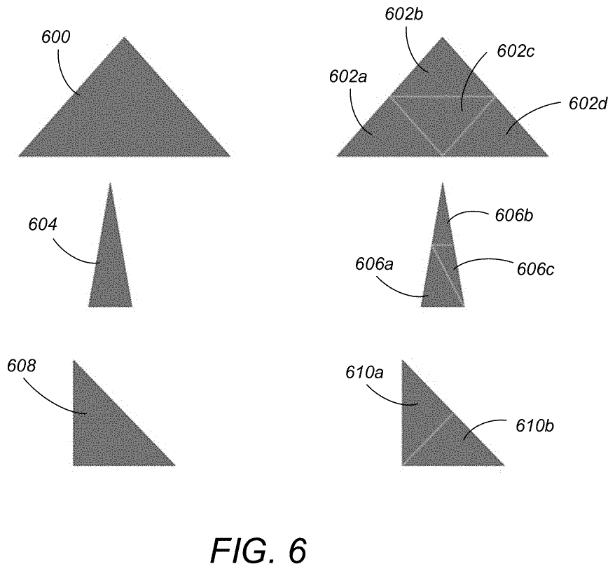

In some implementations, if the determined number of sample points for a polygon is greater than the number of sample points in a template, the module 304 can segment the polygon into two or more corresponding polygons (e.g., sub-polygons), and determine a spatial pattern of sample points for each of the sub-polygons individually using the techniques described herein. As an example, as shown in FIG. 6, the module 304 can segment a triangle 600 into four sub-triangles 602a-602d (e.g., by segmenting the triangle 600 along vectors extending between midpoints of the edges of the triangle). As another example, the module 304 can segment a triangle 604 into three sub-triangles 606a-606c (e.g., by segmenting the triangle 604 along a vector extending between midpoints of two edges of the triangle, and along a vector extending between a midpoint of an edge of the triangle and an opposing vertex of the triangle). As another example, the module 304 can segment a triangle 608 into two sub-triangles 610a and 610b (e.g., by segmenting the triangle 608 along a vector extending between a midpoint of an edge of the triangle and an opposing vertex of the triangle). In some implementations, a polygon can be segmented such that the resulting sub-polygons are equal (or approximately) equal in size or area. In some implementations, a polygon can be segmented such that at least some of the resulting sub-polygons have different sizes or areas.

As described above, in some implementations, the encoder 102 can filter at least some of the sample points (e.g., using a module 306), such that some of the sample points are discarded or otherwise omitted from further processing. Filtering sample points can be beneficial, for example, in reducing the size or length of the encoded content, increasing the speed at which encoded content 114 is generated, and/or decreasing the computational resources that a consumed to generate the encoded content 114. Filtering sample points also can be beneficial, for example, in enhancing the quality of the encoded content, and/or improving the consistency of the encoded content (e.g., by reducing the occurrence of oversampling or incoherent sampling).

In some implementations, the module 306 can filter sample points that are less than a threshold distance D from another sample point (e.g., such that the remaining sample points are separated from one another by at least D). This technique can be beneficial, for example, in facilitating the generation of evenly distributed spatial patterns of sample points across a polygon, which can improve the quality and/or consistency of the sampling process (e.g., by reducing groups of sample points that are concentrated in a particular area within a polygon).

In some implementations, the module 306 also can filter sample points that are less than the threshold distance D from an edge of a polygon. This technique can be beneficial, for example, in facilitating the generation of evenly distributed spatial patterns of sample points across polygons that are adjacent to one another, which can also improve the quality and/or consistency of the sampling process (e.g., by reducing groups of sample points that are concentrated in a particular area that extends across adjacent polygons).

In some implementation, the threshold distance D can be automatically determined by the encoder 102. For example, the threshold distance D can be automatically selected by the encoder 102 based on the number of sample points for a polygon, the number of sample points for the entirety of the polygon mesh, the area of the polygon, the area of the entire polygon mesh, a specified level of quality or detail for the encoding process, etc. In some implementations, the threshold distance D can be selected, at least in part, based on input by a user.

In some implementations, the module 306 can filter the sample points by comparing the location of each newly added sample point to the locations of N previously added sample points that are nearest to the sample point (e.g., the N nearest neighbors to the newly added sample point). If the distance between the newly added sample point is less than the threshold distance D from any of its N nearest neighbors, the module 306 can filter out that sample point (e.g., such that it is not used to sample the polygon).

In some implementations, the module 306 can also filter the sample points by comparing the location of each newly added sample point to the locations of the edges of the polygon that enclose the sample points. If the distance between the newly added sample point is less than the threshold distance D from any of the edges of the polygon, the module 306 can filter out that sample point (e.g., such that it is not used to sample the polygons).

In some implementations, the module 306 can filter the sample points, at least in part, by quantizing a subset of the sample points such that their spatial coordinates are mapped to integer values. For example, the module 306 can determine the set of sample points B that are within the threshold distance D from an edge of a polygon (e.g., also referred to as “boundary points”). For each of the sample points B, the module 306 can divide the spatial coordinates of the sample point by the threshold distance D, and round the result to the nearest integer. Accordingly, if two points are separated from one another by a distance less than or equal to the threshold distance D, then their quantized coordinates will either be equal to one another or differ by ±1.

Further, the sample points B can be ordered according to their Morton order. Morton order (often referred to as “Z-order”) is used to map multidimensional data (e.g., spatial coordinates) to one dimension while preserving locality of the data points. The Morton order of a point can be calculated by interleaving the binary representations of its coordinate values. Once the data is sorted into this ordering, a one-dimensional data structure can be used to represent the data, such as binary search trees, B-trees, skip lists or hash tables. The resulting ordering can also be described as the order that would be obtained from a depth-first traversal of a quadtree or octree.

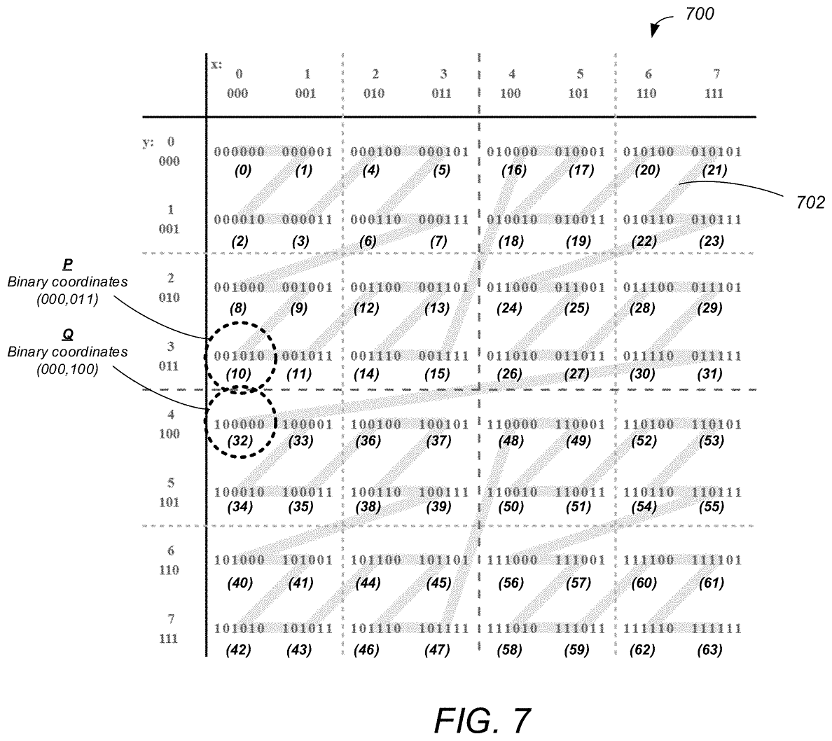

FIG. 7 shows a table 700 representing an example Morton order. In this example, an x-coordinate for a point is represented by three bits (e.g., as indicated in the horizontal headings), and a y-coordinate for the point is represented by three bits (e.g., as indicated in the vertical headings). The Morton order of a point can be calculated by interleaving the binary representations of its x-coordinate and y-coordinate values (shown in the cells of the table). For reference, the decimal value of each Morton order is shown in parenthesis in each of the cells. When sorted in value from lowest to highest, the Morton orders of the points follows the order indicated the curve 702.

The module 306 can perform one or more nearest neighbor searches on the ordered sample points B to determine whether a point is within a threshold distance D from another point.

According to a first nearest neighbor search, for each point P(i), the module 306 finds the minimum nearest neighbor among the Δ previous samples P(i−1), P(i−2), . . . , P(i−Δ) in the Morton order. If the distance to the nearest neighbor is less than the threshold distance D, then the point is discarded.

In practice, this first search provides a good approximation of a nearest neighbor search. However, in some implementations, it may not capture the actual nearest neighbor when significant jumps in terms of Morton order are observed between neighboring points. For example, as shown in FIG. 7, two points P and Q may be spatially near one another, but may be substantially separated from another one in Morton order (e.g., the point P has a Morton order of 10, whereas the point Q has a Morton order of 32).

A second search can be performed to determine a more accurate approximate nearest neighbor. For example, according to a second search, let N (i, 1), N(i, 2), . . . , N(i, H) be the set of neighbors of a sample point P(i) in the quantized space. Further, for each point N(i, h), a search is performed to determine if that point (e.g., the quantized coordinates of that point) exists in the previously points P(i— 1), P(i— 2), . . . , P(i — N).

Different sets of neighbors can be considered, depending on the implementation. As an example, sets of neighbors can be determined based on the connectivity (e.g., voxel connectivity) of regions to a unit square in quantized space. In some implementations, sets of neighbors can correspond to 6-connectivity, and/or 18-connectivity, or 26-connectivity of quantized space.

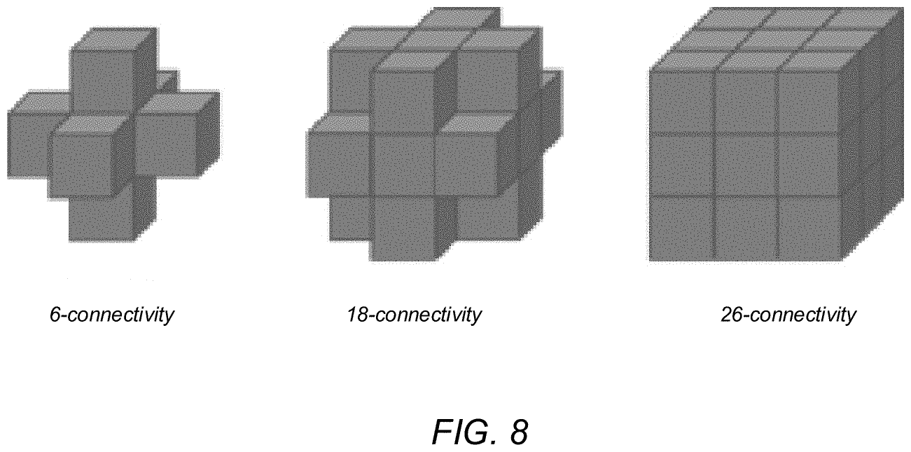

FIG. 8 shows example 6-connectivity, 18-connectivy, and 26-conectivity of quantized space. In these examples, a center unit cube represents the quantized location of a sample point P(i)

In a 6-connectivity configuration (left panel), six unit cubes adjacent to the center unit cube are searched. These unit cubes include unit cubes that share a common face with the center unit cube.

In an 18-connectivity configuration (middle panel), 18 unit cubes adjacent to the center unit cube are searched. These unit cubes include the same unit cubes from the 6-connectivity configuration, and additionally include the unit cubes that share a common edge with the center unit cube.

In a 26-connectivity configuration (right panel), 26 unit cubes adjacent to the center unit cube are searched. These unit cubes include the same unit cubes from the 18-connectivity configuration, and additionally include the unit cubes that share a common vertex with the center unit cube.

In some implementations, the module 306 can perform a single nearest neighbor search (e.g., the first search or the second search described above).

In some implementations, the module 306 can perform multiple nearest neighbor search sequentially. For example, the module 306 can perform the first search described above to filter out some of the sample points. Subsequently, the module 306 can perform the second search described above on the remaining sample points to filter out additional sample points. This can be beneficial, for example, as the first search may be less computationally demanding to perform compared to the second search, whereas the second search may be more comprehensive than the first search. Accordingly, the first search can be initially performed to filter out some of the sample points, such that the more computationally demanding second search need not be performed on the filtered out sample points. Subsequently, the second search can be performed on the remaining sample points to determine comprehensive whether any sample points are within the threshold distance D from any other sample point, and to filter out those points.

Other nearest neighbor searches can be performed, either instead of or in addition to those described above.

For instance, a third search can be perform by applying a binary search. As an example, according to a third search, let MN(i, h) be the Morton code of N(i, h). If MN(i, h)≥MP(i−Δ) and MN(i, h)<MP(i−Δ), do nothing (e.g., as these points have already been captured by the initial search). However, if MN(i, h)<MP(i−Δ), then apply binary search to the integer interval [i−Δ— 1— MPU— A)+MN(i, h), i−Δ— 1]. Further, if MN(i, h)≥MP(i+Δ), then apply binary search to the integer interval [i+A+1, i+Δ+1+MP(i+Δ) — MN(i, h)]

As another example, a fourth search can be performed using a look up table. For instance, according to the fourth search, let C=[0, . . . , 2^{c}−1] X [0, . . . , 2^{c}−1] X [0, . . . , 2^{c}−1] be the bounding cube of B (e.g., B c C). First, a look up table is obtained that maps any point X of C to (i) “true” (or -1) if the point does not belong to B, and (ii) “false” (or the index of X in B), otherwise. Further, the look up table is used to check if MN(i, h) belongs to B. If MN(i, h) belongs B, MN(i, h) is added to S(j).

In some implementations, the look up table can be implemented as a table or using any hierarchical structure (e.g., octree, kd-tree, hierarchical grids, etc.) to save memory by leveraging the sparse nature of a point cloud.

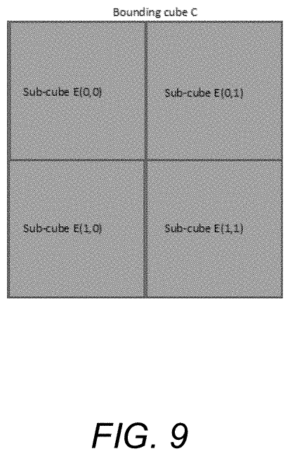

Further, in some implementations, allocating a look up table that holds C may be expensive in terms of memory consumption. To reduce such requirements, the bounding cube C can be partitioned into smaller sub-cubes {E(a, b, c)} of size 2e (e.g., as shown in FIG. 9). Since the points are traversed in Morton order, all the points in one sub-cube will be traversed in sequence before switching the next sub-cube. Therefore, only a look up table that is able to store a single sub-cube is needed. The look up table can be initialized every time P(i) enters a new sub-cube. Further, in some implementations, only the point of B in that sub-cube would be added to the look up tables.

In some implementations, for the points on the boundary of the sub-cube, the neighborhood relationship across sub-cubes boundaries can be ignored. In some implementations, for the points on the boundary of the sub-cube, a binary search can be used (e.g., according to the third search described above) to compute to determine if their neighbors exists or not.

In some implementations, both the third search and the fourth search can be performed (e.g., either instead of or in addition to the first search and/or the second search). In some implementations, only one of the third search or the fourth search can be performed (e.g., either instead of or in addition to the first search and/or the second search).

Further, in some embodiments, at least some of the techniques described herein can performed according to a fixed-point implementation.

Further, in some embodiments, instead of determining a distance between points, the encoder 102 can determine a squared distance between points. This can be beneficial, for example, as determining the distance between points may include performing one or more square root operations (which may be computationally expensive), whereas determining the squared distance between points may not.

Further, in some embodiments, an adaptive sampling technique can be performed, whereby the threshold distance D is selected on a local geometry curvature and/or an attributes gradient of the polygon mesh.

### Example Processes

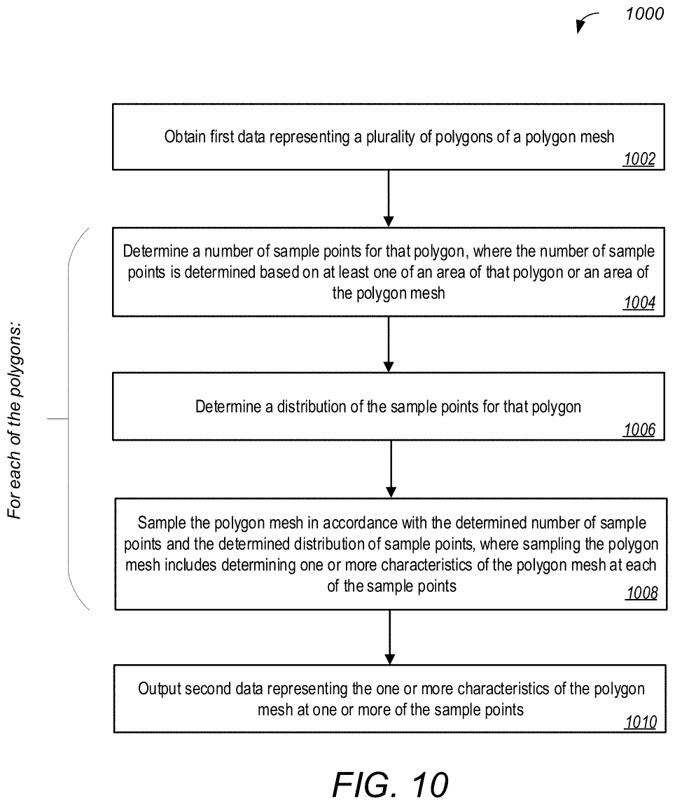

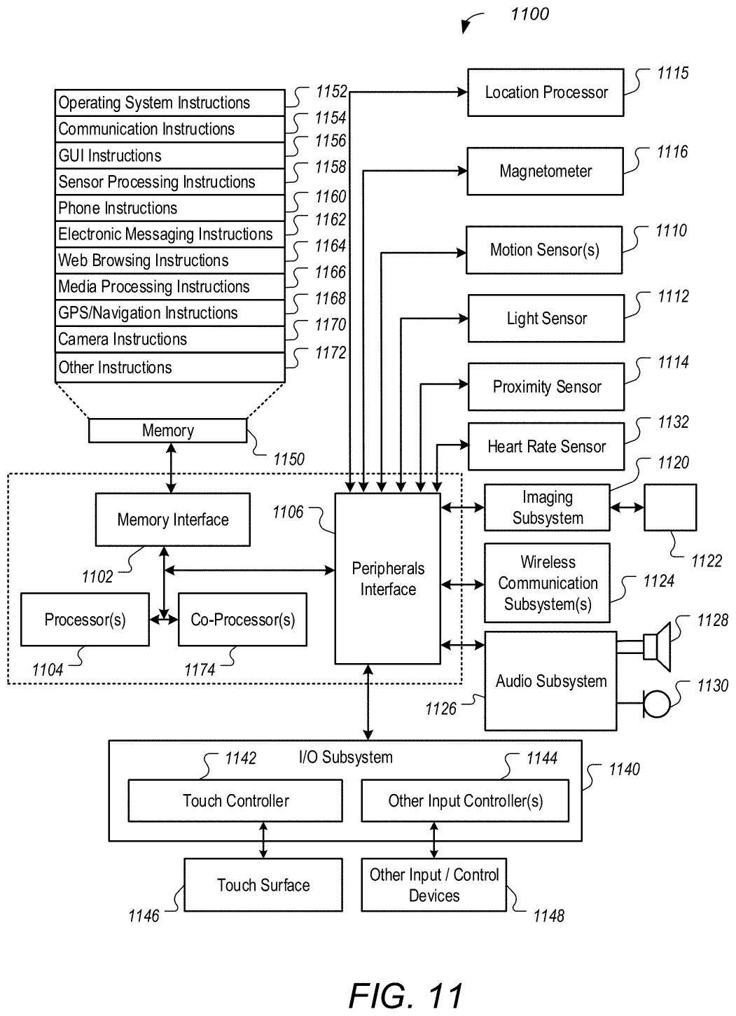

FIG. 10 shows an example process 1000 for encoding information regarding a polygon mesh. The process 1000 can be performed, at least in part, using a system having one or more devices (e.g., one or more of the computer systems shown in FIG. 11).

According to the process 1000, a system obtains first data representing a plurality of polygons of a polygon mesh (block 1002). In some implementations, the plurality of polygons can include a plurality of triangles. Further, the polygon mesh can define one or more three-dimensional surfaces. Example polygons and polygon meshes are shown, for example, in FIG. 2A

Further, the system performs several operations for each of the polygons.

For example, for each of the polygons, the system determines a number of sample points for that polygon (block 1004). The number of sample points is determined based on at least one of an area of that polygon or an area of the polygon mesh.

In some implementations, for each of the polygons, the number of sample points for that polygon can be determined based on the area of that polygon, the area of the polygon mesh, and a specified number of sample points for the polygon mesh. In some implementations, the specified number of sample points can be a pre-determined value (e.g., specified by a user) or automatically determined by the system (e.g., based on the size of the polygon mesh, a specified level of quality or detail for the encoding process, etc.). An example technique for calculating the number of sample points for a polygon in this manner is described, for instance, with reference to Eq. 1.

In some implementations, for each of the polygons, the number of sample points for that polygon can be determined based on the area of the polygon mesh, a pre-determined number of sample points for the polygon mesh, and a plurality of vectors representing a plurality of edges of the polygon. An example technique for calculating the number of sample points for a polygon in this manner is described, for instance, with reference to Eqs. 2-4.

Further, for each of the polygons, the system determines a distribution of the sample points for that polygon (block 1006).

In some implementations, for each of the polygons, determining the distribution of the sample points for that polygon can include obtaining a template representing a spatial pattern of sample points, and applying at least a portion of the template to the polygon. An example templates and spatial patterns of sample points are shown, for example, in FIGS. 4 and 5.

In some implementations, a template can be rotated relative to the polygon and/or translated relative to the polygon.

In some implementations, multiple instances of a template can be applied to the polygon (e.g., by tiling or repeating multiple instances of a template across the polygon, such that they collectively enclose some or all of the polygon).

In some implementations, for each of the polygons, determining the distribution of the sample points for that polygon can include determining a random or pseudo-random spatial pattern of sample points.

In some implementations, determining the distribution of the sample points for that polygon can include filtering some of the sample points from the distribution. For example, for each of the polygons, the system can add a sample point to the distribution, and determine whether the added sample point is less than a threshold distance from one or more other sample points in the distribution. If the added sample point is less than the threshold distance from the one or more other sample points in the distribution, the system can remove the added sample point from the distribution.

In some implementations, at least some of the sample points can be determined based on a Morton order of the one or more sample points. An example technique for determining sample points in this manner as described, for instance, with reference to FIG. 7.

In some implementations, at least some of the sample points can be determined by comparing the location of each newly added sample point to the locations of one or more previously added sample points that are nearest to the sample point (e.g., the nearest neighbors). For example, the system can quantize a spatial region of the polygon mesh into a plurality of cubes, determine a first cube corresponding to the added sample point, and determine one or more second cubes adjacent to the first cube. Further, the system can select one or more sample points from the one or more second cubes for comparison. An example technique for determining sample points in this manner as described, for instance, with reference to FIG. 8.

In some implementations, for each of the polygons, determining the distribution of the sample points for that polygon can include selecting one or more vertices of the polygon as one or more of the sample (e.g., prior to selecting other sample points for that polygon).

In some implementations, at least one of the polygons can be segmented in to two corresponding polygons (e.g., as described with reference to FIG. 6).

Further, for each of the polygons, the system samples the polygon mesh in accordance with the determined number of sample points and the determined distribution of sample points (block 1008). Sampling the polygon mesh includes determining one or more characteristics of the polygon mesh at each of the sample points. Example characteristics of the polygon mesh at each of the sample points include a spatial location corresponding to that sample point, a color corresponding to that sample point, a texture corresponding to that sample point, and/or a surface normal corresponding to that sample point.

The system outputs second data representing the one or more characteristics of the polygon mesh at one or more of the sample points (block 1010).

### Example Computer System

FIG. 11 is a block diagram of an example device architecture 1100 for implementing the features and processes described in reference to FIGS. 1-9. For example, the architecture 1100 can be used to implement the system 100 and/or one or more components of the system 100. The architecture 1100 may be implemented in any device for generating the features described in reference to FIGS. 1-10, including but not limited to desktop computers, server computers, portable computers, smart phones, tablet computers, game consoles, wearable computers, holographic displays, set top boxes, media players, smart TVs, and the like.

The architecture 1100 can include a memory interface 1102, one or more data processor 1104, one or more data co-processors 1174, and a peripherals interface 1106. The memory interface 1102, the processor(s) 1104, the co-processor(s) 1174, and/or the peripherals interface 1106 can be separate components or can be integrated in one or more integrated circuits. One or more communication buses or signal lines may couple the various components.

The processor(s) 1104 and/or the co-processor(s) 1174 can operate in conjunction to perform the operations described herein. For instance, the processor(s) 1104 can include one or more central processing units (CPUs) and/or graphics processing units (GPUs) that are configured to function as the primary computer processors for the architecture 1100. As an example, the processor(s) 1104 can be configured to perform generalized data processing tasks of the architecture 1100. Further, at least some of the data processing tasks can be offloaded to the co-processor(s) 1174. For example, specialized data processing tasks, such as processing motion data, processing image data, encrypting data, and/or performing certain types of arithmetic operations, can be offloaded to one or more specialized co-processor(s) 1174 for handling those tasks. In some cases, the processor(s) 1104 can be relatively more powerful than the co-processor(s) 1174 and/or can consume more power than the co-processor(s) 1174. This can be useful, for example, as it enables the processor(s) 1104 to handle generalized tasks quickly, while also offloading certain other tasks to co-processor(s) 1174 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 1104 for further analysis.

Sensors, devices, and subsystems can be coupled to peripherals interface 1106 to facilitate multiple functionalities. For example, a motion sensor 1110, a light sensor 1112, and a proximity sensor 1114 can be coupled to the peripherals interface 1106 to facilitate orientation, lighting, and proximity functions of the architecture 1100. For example, in some implementations, a light sensor 1112 can be utilized to facilitate adjusting the brightness of a touch surface 1146. In some implementations, a motion sensor 1110 can be utilized to detect movement and orientation of the device. For example, the motion sensor 1110 can include one or more accelerometers (e.g., to measure the acceleration experienced by the motion sensor 1110 and/or the architecture 1100 over a period of time), and/or one or more compasses or gyros (e.g., to measure the orientation of the motion sensor 1110 and/or the mobile device). In some cases, the measurement information obtained by the motion sensor 1110 can be in the form of one or more a time-varying signals (e.g., a time-varying plot of an acceleration and/or an orientation over a period of time). Further, display objects or media may be presented according to a detected orientation (e.g., according to a “portrait” orientation or a “landscape” orientation). In some cases, a motion sensor 1110 can be directly integrated into a co-processor 1174 configured to process measurements obtained by the motion sensor 1110. For example, a co-processor 1174 can include one more accelerometers, compasses, and/or gyroscopes, and can be configured to obtain sensor data from each of these sensors, process the sensor data, and transmit the processed data to the processor(s) 1104 for further analysis.

Other sensors may also be connected to the peripherals interface 1106, such as a temperature sensor, a biometric sensor, or other sensing device, to facilitate related functionalities. As an example, as shown in FIG. 11, the architecture 1100 can include a heart rate sensor 1132 that measures the beats of a user's heart. Similarly, these other sensors also can be directly integrated into one or more co-processor(s) 1174 configured to process measurements obtained from those sensors.

A location processor 1115 (e.g., a GNSS receiver chip) can be connected to the peripherals interface 1106 to provide geo-referencing. An electronic magnetometer 1116 (e.g., an integrated circuit chip) can also be connected to the peripherals interface 1106 to provide data that may be used to determine the direction of magnetic North. Thus, the electronic magnetometer 1116 can be used as an electronic compass.

An imaging subsystem 1120 and/or an optical sensor 1122 can be utilized to generate images, videos, point clouds, and/or other any other visual information regarding a subject or environment. As an example, the imaging subsystem 1120 can include one or more still cameras and/or optical sensors (e.g., a charged coupled device [CCD] or a complementary metal-oxide semiconductor [CMOS] optical sensor) configured to generate still images of a subject or environment. As another example, the imaging subsystem 1120 can include one or more video cameras and/or optical sensors configured to generate videos of a subject or environment. As another example, the imaging subsystem 1120 can include one or more depth sensors (e.g., LiDAR sensors) configured to generate a point cloud representing a subject or environment. In some implementations, at least some of the data generated the imaging subsystem 1120 and/or an optical sensor 1122 can include two-dimensional data (e.g., two-dimensional images, videos, and/or point clouds). In some implementations, at least some of the data generated the imaging subsystem 1120 and/or an optical sensor 1122 can include three-dimensional data (e.g., three-dimensional images, videos, and/or point clouds).

The information generated by the imaging subsystem 1120 and/or an optical sensor 1122 can be used to generate corresponding polygon meshes and/or to sample those polygon meshes (e.g., using the systems and/or techniques described herein). As an example, at least some of the techniques described herein can be performed at least in part using one or more data processors 1104 and/or one or more data co-processors 1174.

Communication functions may be facilitated through one or more communication subsystems 1124. The communication subsystem(s) 1124 can include one or more wireless and/or wired communication subsystems. For example, wireless communication subsystems can include radio frequency receivers and transmitters and/or optical (e.g., infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication sub system 1124 can depend on the communication network(s) or medium(s) over which the architecture 1100 is intended to operate. For example, the architecture 1100 can include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. The wireless communication subsystems can also include hosting protocols such that the architecture 1100 can be configured as a base station for other wireless devices. As another example, the communication subsystems may allow the architecture 1100 to synchronize with a host device using one or more protocols, such as, for example, the TCP/IP protocol, HTTP protocol, UDP protocol, and any other known protocol.

An audio subsystem 1126 can be coupled to a speaker 1128 and one or more microphones 1130 to facilitate voice-enabled functions, such as voice recognition, voice replication, digital recording, and telephony functions.

An I/O subsystem 1140 can include a touch controller 1142 and/or other input controller(s) 1144. The touch controller 1142 can be coupled to a touch surface 1146. The touch surface 1146 and the touch controller 1142 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 1146. In one implementation, the touch surface 1146 can display virtual or soft buttons and a virtual keyboard, which can be used as an input/output device by the user.

Other input controller(s) 1144 can be coupled to other input/control devices 1148, such as one or more buttons, rocker switches, thumb-wheel, infrared port, USB port, and/or a pointer device such as a stylus. The one or more buttons (not shown) can include an up/down button for volume control of the speaker 1128 and/or the microphone 1130.

In some implementations, the architecture 1100 can present recorded audio and/or video files, such as MP3, AAC, and MPEG video files. In some implementations, the architecture 1100 can include the functionality of an MP3 player and may include a pin connector for tethering to other devices. Other input/output and control devices may be used.

A memory interface 1102 can be coupled to a memory 1150. The memory 1150 can include high-speed random access memory or non-volatile memory, such as one or more magnetic disk storage devices, one or more optical storage devices, or flash memory (e.g., NAND, NOR). The memory 1150 can store an operating system 1152, such as MACOS, IOS, Darwin, RTXC, LINUX, UNIX, WINDOWS, or an embedded operating system such as VxWorks. The operating system 1152 can include instructions for handling basic system services and for performing hardware dependent tasks. In some implementations, the operating system 1152 can include a kernel (e.g., UNIX kernel).

The memory 1150 can also store communication instructions 1154 to facilitate communicating with one or more additional devices, one or more computers or servers, including peer-to-peer communications. The communication instructions 1154 can also be used to select an operational mode or communication medium for use by the device, based on a geographic location (obtained by the GPS/Navigation instructions 1168) of the device. The memory 1150 can include graphical user interface instructions 1156 to facilitate graphic user interface processing, including a touch model for interpreting touch inputs and gestures; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GPS/Navigation instructions 1168 to facilitate GPS and navigation-related processes; camera instructions 1170 to facilitate camera-related processes and functions; and other instructions 1172 for performing some or all of the processes described herein.

Each of the above identified instructions and applications can correspond to a set of instructions for performing one or more functions described herein. These instructions need not be implemented as separate software programs, procedures, or modules. The memory 1150 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of mesh and point cloud data available from various sources to improve services a mobile device can provide to a user. The present disclosure further contemplates that to the extent mesh and point cloud data representative of personal information data are collected, analyzed, disclosed, transferred, stored, or otherwise used, implementors will comply with well-established privacy policies and/or privacy practices. In particular, such implementers should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such implementers would take any needed steps for safeguarding and securing access to such personal information data and ensuring that others with access to the personal information data adhere to their privacy policies and procedures. Further, such implementers can subject themselves to evaluation by third parties to certify their adherence to widely accepted privacy policies and practices.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising:
obtaining, by one or more processors, first data representing a plurality of polygons of a polygon mesh;
for each of the polygons:
determining, by the one or more processors, a number of sample points for that polygon, wherein the number of sample points is determined based on at least one of an area of that polygon or an area of the polygon mesh,
determining, by the one or more processors, a distribution of the sample points for that polygon, and
sampling, by the one or more processors, the polygon mesh in accordance with the determined number of sample points and the determined distribution of sample points, wherein sampling the polygon mesh comprises determining one or more characteristics of the polygon mesh at each of the sample points; and
outputting, by the one or more processors, second data representing the one or more characteristics of the polygon mesh at one or more of the sample points.

2. The method of claim 1, wherein the plurality of polygons comprises a plurality of triangles.

3. The method of claim 1, wherein the polygon mesh defines one or more three-dimensional surfaces.

4. The method of claim 1, wherein the one or more characteristics of the polygon mesh at each of the sample points comprises at least one of:
a spatial location corresponding to that sample point,
a color corresponding to that sample point,
a texture corresponding to that sample point, or
a surface normal corresponding to that sample point.

5. The method of claim 1, wherein, for each of the polygons, the number of sample points for that polygon is determined based on the area of that polygon, the area of the polygon mesh, and a specified number of sample points for the polygon mesh.

6. The method of claim 1, wherein, for each of the polygons, the number of sample points for that polygon is determined based on the area of the polygon mesh, a pre-determined number of sample points for the polygon mesh, and a plurality of vectors representing a plurality of edges of the polygon.

7. The method of claim 1, wherein, for each of the polygons, determining the distribution of the sample points for that polygon comprises:
obtaining a template representing a spatial pattern of sample points, and
applying at least a portion of the template to the polygon.

8. The method of claim 7, wherein, for each of the polygons, determining the distribution of the sample points for that polygon further comprises at least one of:
rotating the template relative to the polygon, or
translating the template relative to the polygon.

9. The method of claim 7, wherein, for each of the polygons, determining the distribution of the sample points for that polygon further comprises:
applying multiple instances of the template to the polygon.

10. The method of claim 1, wherein, for each of the polygons, determining the distribution of the sample points for that polygon comprises:
determining a random or pseudo-random spatial pattern of sample points.

11. The method of claim 1, wherein, for each of the polygons, determining the distribution of the sample points for that polygon comprises:
adding a sample point to the distribution,
determining whether the added sample point is less than a threshold distance from one or more other sample points in the distribution, and
responsive to determining that the added sample point is less than the threshold distance from the one or more other sample points in the distribution, removing the added sample point from the distribution.

12. The method of claim 1, wherein the one or more sample points are determined based on a Morton order of the one or more sample points.

13. The method of claim 1, wherein the one or more sample points are determined by:
quantizing a spatial region of the polygon mesh into a plurality of cubes,
determining a first cube corresponding to the added sample point,
determining one or more second cubes adjacent to the first cube, and
selecting the one or more sample points from the one or more second cubes.

14. The method of claim 1, further comprising:
segmenting at least one of the polygons into two corresponding polygons.

15. The method of claim 1, wherein, for each of the polygons, determining the distribution of the sample points for that polygon comprises:
selecting one or more vertices of the polygon as one or more of the sample points.

16. A device comprising:
one or more processors; and
memory storing instructions that when executed by the one or more processors, cause the one or more processors to perform operations comprising:
obtaining first data representing a plurality of polygons of a polygon mesh;
for each of the polygons:
determining a number of sample points for that polygon, wherein the number of sample points is determined based on at least one of an area of that polygon or an area of the polygon mesh,
determining a distribution of the sample points for that polygon, and
sampling the polygon mesh in accordance with the determined number of sample points and the determined distribution of sample points, wherein sampling the polygon mesh comprises determining one or more characteristics of the polygon mesh at each of the sample points; and
outputting second data representing the one or more characteristics of the polygon mesh at one or more of the sample points.

17.-30. (canceled)

31. One or more non-transitory, computer-readable storage media having instructions stored thereon, that when executed by one or more processors, cause the one or more processors to perform operations comprising:
obtaining first data representing a plurality of polygons of a polygon mesh;
for each of the polygons:
determining a number of sample points for that polygon, wherein the number of sample points is determined based on at least one of an area of that polygon or an area of the polygon mesh,
determining a distribution of the sample points for that polygon, and
sampling the polygon mesh in accordance with the determined number of sample points and the determined distribution of sample points, wherein sampling the polygon mesh comprises determining one or more characteristics of the polygon mesh at each of the sample points; and
outputting second data representing the one or more characteristics of the polygon mesh at one or more of the sample points.

32.-45. (canceled)
